(19) United States
(12) Patent Application Publication
(10) Pub. No.: US 2014/0036861 A1
(43) Pub. Date: Feb. 6, 2014

(54) HIGH-POWER BASE STATION AND LOW-POWER BASE STATION FOR USE IN HEREROGENEOUS NETWORK AND TRANSMISSION METHODS THEREOF

(71) Applicant: Institute for Information Industry, Taipei (TW)

(72) Inventors: Tsung-Yu TSAI, Tainan City (TW); Hsuan-Li LIN, Taipei City (TW); Chun-Che CHIEN, Taipei City (TW); Shu-Tsz LIU, Taipei City (TW); Chih-Yuan LO, Tainan City (TW); Ta KO, Taipei City (TW)

(73) Assignee: Institute for Information Industry, Taipei (TW)

(21) Appl. No.: 13/957,600

(22) Filed: Aug. 2, 2013

Related U.S. Application Data
(60) Provisional application No. 61/679,080, filed on Aug. 3, 2012.

(51) Int. Cl. H04W 72/08

(52) U.S. Cl. CPC H04W 72/082
USPC 370/330

(57) ABSTRACT

A high-power base station and a low-power base station for use in a heterogeneous network system and transmission methods thereof are provided. Interference caused by the high-power base station in control channels of the heterogeneous network system are avoided effectively based on one of the following strategies: (1) transmitting control information of the low-power base station by the high-power base station in the same control channel; (2) transmitting control information of the low-power base station by the low-power base station attached with a user end in a specific control channel which is pre-defined by the low-power base station; and (3) transmitting control information of the low-power base station by the low-power base station in a specific control channel which is determined based on an offset allocated by the heterogeneous network system.

### PRIORITY

This application claims priority to U.S. Provisional Patent Application No. 61/679,080 filed on Aug. 3, 2012, which is hereby incorporated herein by reference in its entirety.

### FIELD

The present invention relates to a high-power base station and a low-power base station for use in a heterogeneous network system and transmission methods thereof. More specifically, the present invention relates to a heterogeneous network system in which interference caused by a high-power base station in control channels can be avoided, and transmission methods thereof.

### BACKGROUND

Over recent years, heterogeneous network systems which contain a mixture of base stations with different cell coverage such as femto cell, phantom cell, pico cell, and macro cell are highlighted and considered as one of the practical approaches to further enhance the overall system capacity and reduce the coverage hole. However, heterogeneous network systems in which the base station with higher power (referred to as “high-power base station”) such as macro cell can become strong interferers for the base station with lower power (referred to as “low-power base station”) such as pico cell or femto cell and significantly degrade or even intercept their services. The interference problems are especially serious in the inband scenarios with which all the base stations use the same or overlapped spectrum. Therefore, the interference issue is one of the most important concerns in the design of heterogeneous network systems.

The interference problem can be roughly divided into two categories, one is the interference in data channels, and another is the interference in control channels. The former may be solved by allocating different transmission patterns which are in general a set of radio resource (including time and frequency resources) to the base stations in a heterogeneous network system. Taking the 3rd Generation Partnership Project (3GPP) release 10 as an example, the transmission pattern of the macro cell (i.e., a high-power base station) could be allocated a specific periodical subframe set, namely, Almost Blank Subframe (ABS). In such a way, the macro cell should not transmit data or reduce the transmission power in the ABS, and thus the pico cell (i.e., a low-power base station) could have a relatively low interference level in the ABS. Consequently, the overall system performance such as data throughput and system capacity can be improved.

However, the interference in control channels may not be solved by the above approach. The main reason is that all the control channels usually appear in a periodical manner instead of the dynamic assignment in the data channels in the conventional heterogeneous network systems. This fact causes all the control channels appear in the same radio resource (i.e., in the same subframe and resource block). Therefore, all the control channels have to suffer the interference caused by other base stations, especially for the control channels corresponding to the low-power base station. Since the control channels in general carry essential control information or synchronization signals related to connections or communications between base stations and user ends, the interference in the control channels could cause serious impact to the quality of service (QoS) of the conventional heterogeneous network systems.

In view of this, an urgent need exists in the art to provide a solution to improve the interference in control channels of the conventional heterogeneous network systems.

### SUMMARY

A primary objective of the present invention is to improve the interference in control channels of the conventional heterogeneous network systems. In a first aspect, to achieve the aforesaid objective, certain embodiments of the present invention provide a high-power base station for use in a heterogeneous network system in which at least one low-power base station has time and frequency synchronization with the high-power base station in a control channel and a Cell Range Expansion (CRE) bias with the high-power base station. The high-power base station comprises a processor and a transceiver connected electrically with the processor. The processor is configured to determine at least one low-power base station candidate from the at least one low-power base station, while the transceiver is configured to transmit control information of the at least one low-power base station candidate to at least one user end in the control channel.

In the first aspect, to achieve the aforesaid objective, certain embodiments of the present invention further provide a transmission method applied to a high-power base station for use in a heterogeneous network system in which at least one low-power base station has time and frequency synchronization with the high-power base station in a control channel and a CRE bias with the high-power base station. The high-power base station comprises a processor and a transceiver connected electrically with the processor. The transmission method comprises the following steps:

(a) determining at least one low-power base station candidate from the at least one low-power base station by the processor; and

(b) transmitting control information of the at least one low-power base station candidate to at least one user end in the control channel by the transceiver.

Based on the aforesaid structure of the high-power base station in the first aspect according to certain embodiments, the at least one user end receives control information of the low-power base station from the high-power base station in the same control channels. Therefore, the interference caused by the high-power base station in control channels of the heterogeneous network system can be avoided effectively. Likewise, the transmission method of the first aspect is applied to the high-power base station to implement the same effects.

In a second aspect, to achieve the aforesaid objective, certain embodiments of the present invention provide a low-power base station for use in a heterogeneous network system in which one high-power base station has time and frequency synchronization with the low-power base station in a control channel and a CRE bias with the low-power base station and at least one user end is attached to the low-power base station. The low-power base station comprises a processor and a transceiver connected electrically with the processor. The processor is configured to define a specific control channel separated from the control channel in time or frequency, while the transceiver is configured to transmit control information of the low-power base station to the at least one user end in the specific control channel.

In the second aspect, to achieve the aforesaid objective, certain embodiments of the present invention further provide a transmission method applied to a low-power base station for use in a heterogeneous network system in which one high-power base station has time and frequency synchronization with the low-power base station in a control channel and a CRE bias with the low-power base station and at least one user end is attached to the low-power base station. The low-power base station comprises a processor and a transceiver connected electrically with the processor. The transmission method comprises the following steps:

(a) defining a specific control channel separated from the control channel in time or frequency by the processor; and

(b) transmitting control information of the low-power base station to the at least one user end in the specific control channel by the transceiver.

Based on the aforesaid structure of the low-power base station in the second aspect, the at least one user end attached to the low-power base station receives control information of the low-power base station from the low-power base station in a specific control channel which is pre-defined by the low-power base station to be separated from the control channel in time or frequency. Therefore, the interference caused by the high-power base station in control channels of the heterogeneous network system can be avoided effectively. Likewise, the transmission method of the second aspect is applied to the low-power base station to implement the same effects.

In a third aspect, to achieve the aforesaid objective, certain embodiments of the present invention provide a high-power base station for use in a heterogeneous network system in which at least one low-power base station has a CRE bias with the high-power base station and transmits its control information to at least one user end in a low-power control channel based on a low-power offset allocated by the heterogeneous network system. The high-power base station comprises a processor and a transceiver connected electrically with the processor. The processor is configured to determine a high-power control channel separated from the low-power control channel in time or frequency, while the transceiver is configured to transmit control information of the high-power base station to the at least one user end in the high-power control channel.

In the third aspect, to achieve the aforesaid objective, certain embodiments of the present invention further provide a transmission method applied to a high-power base station for use in a heterogeneous network system in which at least one low-power base station has a CRE bias with the high-power base station and transmits its control information to at least one user end in a low-power control channel based on a low-power offset allocated by the heterogeneous network system. The high-power base station comprises a processor and a transceiver connected electrically with the processor. The transmission method comprises the following steps:
(a) determining a high-power control channel separated from the low-power control channel in time or frequency by the processor; and
(b) transmitting control information of the high-power base station to the at least one user end in the high-power control channel by the transceiver.

In the third aspect, to achieve the aforesaid objective, certain embodiments of the present invention provide a low-power base station for use in a heterogeneous network system in which one high-power base station has a CRE bias with the low-power base station and transmits its control information to at least one user end in a high-power control channel. The low-power base station comprises a processor and a transceiver connected electrically with the processor. The processor is configured to determine a low-power control channel separated from the high-power control channel in time or frequency according to a low-power offset allocated by the heterogeneous network system, while the transceiver is configured to transmit control information of the low-power base station to the at least one user end in the low-power control channel.

In the third aspect, to achieve the aforesaid objective, certain embodiments of the present invention further provide a transmission method applied to a low-power base station for use in a heterogeneous network system in which one high-power base station has a CRE bias with the low-power base station and transmits its control information to at least one user end in a high-power control channel. The low-power base station comprises a processor and a transceiver connected electrically with the processor. The transmission method comprises the following steps:
(a) determining a low-power control channel separated from the high-power control channel in time or frequency according to a low-power offset allocated by the heterogeneous network system by the processor; and
(b) transmitting control information of the low-power base station to the at least one user end in the low-power control channel by the transceiver.

Based on the aforesaid structure of the high-power base station or that of the low-power base station in the third aspect, the user end receives control information of the low-power base station from the low-power base station in the low-power control channel which is determined based on a low-power offset allocated by the heterogeneous network system to be separated from the high-power control channel in which the high-power base station transmits its control information in time or frequency. Therefore, the interference caused by the high-power base station in control channels of the heterogeneous network system can be avoided effectively. Likewise, the transmission methods of the third aspect are applied to the high-power base station and the at least one low-power base station to implement the same effects.

The detailed technology and preferred embodiments implemented for the present invention are described in the following paragraphs accompanying the appended drawings for persons skilled in the art to well appreciate the features of the claimed invention.

### BRIEF DESCRIPTION OF THE DRAWINGS

FIG. 1A is a structural schematic view of a high-power base station according to a first embodiment of the present invention;

FIG. 1B is a schematic view illustrating channel status of the heterogeneous network system in a time-frequency two-dimensional domain according to the first embodiment of the present invention;

FIG. 1C is a flowchart diagram of a transmission method according to a second embodiment of the present invention;

FIG. 2A is a structural schematic view of a low-power base station according to a third embodiment of the present invention;

FIG. 2B is a schematic view illustrating channel status of the heterogeneous network system in a time-frequency two-dimensional domain according to the third embodiment of the present invention;

FIG. 2C is a flowchart diagram of a transmission method according to a fourth embodiment of the present invention;

FIG. 3A is a structural schematic view of a high-power base station and a low-power base station according to a fifth embodiment of the present invention;

FIG. 3B is a schematic view illustrating channel status of the heterogeneous network system in a time-frequency two-dimensional domain according to the fifth embodiment of the present invention; and

FIG. 3C is a flowchart diagram of transmission methods according to a sixth embodiment of the present invention.

### DETAILED DESCRIPTION

In the following description, the present invention will be explained with reference to example embodiments thereof. However, these example embodiments are not intended to limit the present invention to any specific examples, embodiments, environment, applications or particular implementations described in these embodiments. Therefore, the description of these example embodiments is only for the purpose of illustration rather than to limit the present invention. In the following embodiments and the attached drawings, elements unrelated to the present invention are omitted from the depictions; and dimensional relationships among individual elements in the attached drawings are illustrated only for ease of understanding but not to limit the actual scales.

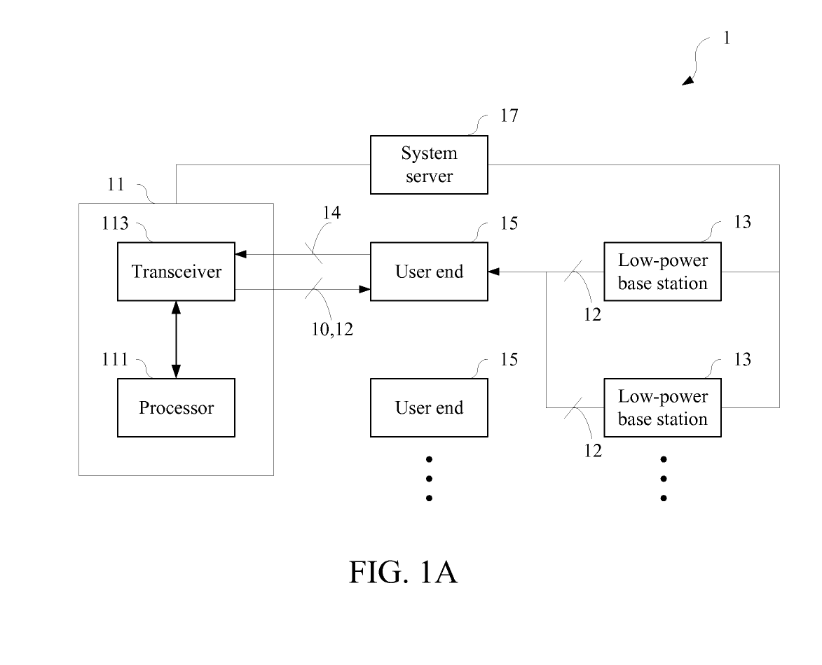

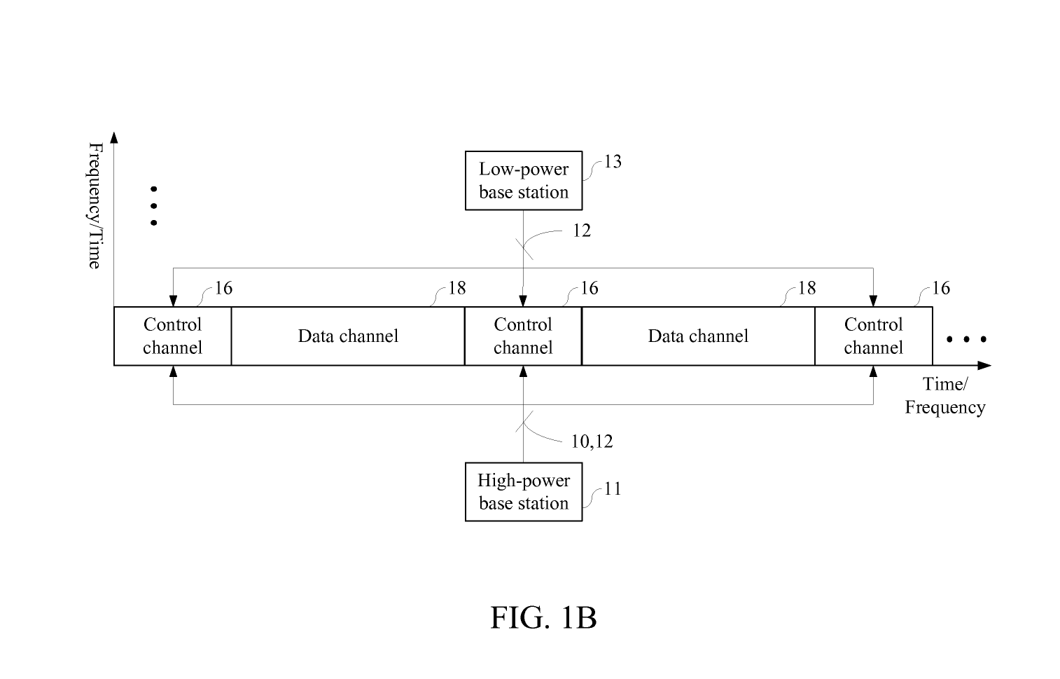

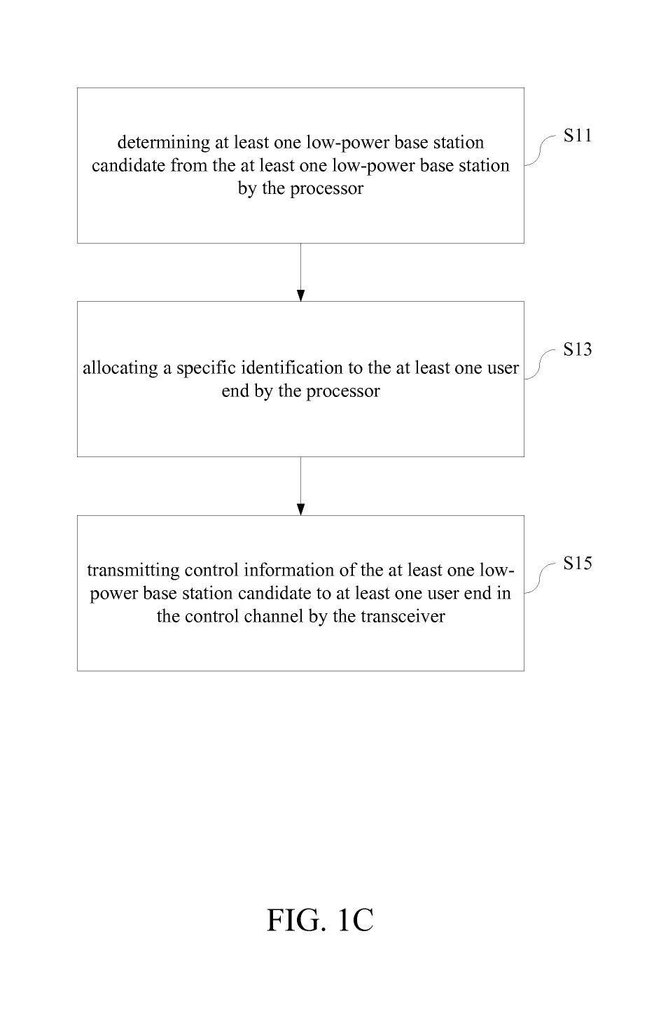

In the first aspect, a first embodiment of the present invention provides a high-power base station for use in a heterogeneous network system in which at least one low-power base station has time and frequency synchronization with the high-power base station in a control channel and a CRE bias with the high-power base station, and a schematic structural view of which is show in FIG. 1A.

As shown in FIG. 1A, a heterogeneous network system 1 comprises a high-power base station 11, at least one low-power base station 13 (i.e., one or more low-power base stations) and at least one user end 15 (i.e., one or more user ends), and the high-power base station 11 comprises a processor 111 and a transceiver 113 connected electrically with the processor 111.

The at least one low-power base station 13 is deployed in the coverage range of the high-power base station 11 and has a CRE bias with the high-power base station 11. In other words, the at least one low-power base station 13 has a power bias (such as 9 dB bias stipulated in the LTE series) with the high-power base station 11, and the at least one user end 15 would be connected with the at least one low-power base station 13 rather than the high-power base station 11 if the power difference between the high-power base station 11 and the at least one low-power base station 13 is within a range of the power bias. The details of the CRE bias can be appreciated readily to persons skilled in the art, and thus will not be further described herein. Note that the LTE series at least includes the LTE and the LTE-A systems.

FIG. 1B is a schematic view illustrating channel status of the heterogeneous network system 1 in a time-frequency two-dimensional domain. In FIG. 1B, one axis represents time while another axis represents frequency, and vice versa. As shown in FIG. 1A and FIG. 1B, the at least one low-power base station 13 has time and frequency synchronization with the high-power base station 11 in a periodic control channel 16. Specifically, the high-power base station 11 and the at least one low-power base station 13 have obtained subframe-level synchronization with which the subframe boundaries of these base stations can be regarded as aligned. Moreover, theses base stations transmit their control information in the same resource block.

Therefore, if the high-power base station 11 transmits its control information 10 to the at least one user end 15 in a control channel such as the control channel 16 in which the at least one low-power base station 13 transmit its control information 12 to the at least one user end 15, the control information 12 with lower power could be interfered by the control information 10 with higher power in the control channel 16. The control information 10 comprises any information which could assist the at least one user end 15 to connect with the high-power base station 11, while the control information 12 comprises any information which could assist the at least one user end 15 to connect with the at least one low-power base station 13.

In this embodiment, the at least one user end 15 has obtained time and frequency synchronization to the high-power base station 11. To improve the overall system capacity, it is more preferable that the at least one user end 15 should be served by the at least one low-power base station 13 rather than the high-power base station 11. As a result, the load of the high-power base station 11 can be reduced and the spectrum re-use can be improved even when the high-power base station 11 has higher signal strength than that of the at least one low-power base station 13.

Under the CRE bias condition, there is a margin value (e.g., 9 dB) in the design of the heterogeneous network system 1. Therefore, the at least one low-power base station 13 still has a higher priority for the connection to the at least one user end 15 when its signal strength is weaker than that of the high-power base station 11 and the strength difference is within the margin value.

However, as described before, the control information 12 with lower power could be interfered by the control information 10 with higher power in the control channel 16, so it is possible that the at least one user end 15 can not successfully receive the control information 12 of the at least one low-power base station 13 due to the strong interference power from the high-power base station 11 even when the at least one low-power base station 13 has higher priority to be connected.

It may cause serious problem since the periodic control channel 16 carries essential information for the at least one user end 15 to connect to the at least one low-power base station 13, and thus the handover from the high-power base station 11 to the at least one low-power base station 13 for the at least one user end 15 may not be practical due to the severe interference when the at least one user end 15 receives the control information 12 from the at least one low-power base station 13 in the periodic control channel 16.

To solve the problem, the processor 111 is configured to determine at least one low-power base station candidate from the at least one low-power base station 13, while the transceiver 113 is configured to transmit the control information 12 of the at least one low-power base station candidate to the at least one user end 15 in the periodic control channel 16. As shown in FIG. 1A, the high-power base station 11 may communicate with the at least one low-power base station 13 via a system server 17 to obtain wanted information about the at least one low-power base station 13, such as control information 12. The system server 17 and its operations are not used to limit the present invention, and the high-power base station 11 may also obtain the information about the at least one low-power base station 13 via other mechanisms in another embodiment.

Optionally, the processor 111 determines at least one low-power base station candidate from the at least one low-power base station 13 according to a request 14 of the at least one user end 15. The number of the request 14 is dependent on that of the at least one user end 15. Under some request/response protocols, in response to one or more requests 14 transmitted by one or more user end 15, the transceiver 113 may transmit one individual response, more individual responses or a merged response (not shown) to the at least one user end 15. The response can be transmitted by unicasting to one user end 15 or broadcasting to more user end 15.

The processor 111 may allocate a specific identification to the at least one user end 15 and use the specific identification to carry one individual response, more individual responses or a merged response so that the at least one user end 15 receives the control information 12 of the at least one low-power base station candidate according to the specific identification in a scheduling channel (not shown). The number of the specific identification is dependent on that of the at least one user end 15. Note that the specific identification could be pre-determined or determined dynamically by the processor 111.

For example, upon the transceiver 113 of the high-power base station 11 receives the request 14 from the at least one low-power base station 13, it could merge the response to the received request 14 into one message and transmits the message (not shown) in a data channel 18. In addition, the transceiver 113 of the high-power base station 11 transmits the scheduling information of the messages in a conventional logical channel (e.g., a scheduling channel) based on the specific identification. Then, the at least one low-power base station 13 could recognize the specific identification in the conventional logical channel and accordingly find the message carrying the response. Moreover, for other user ends 15 which does not send requests 14 or does not need the control information 12, they could simply ignore the scheduling information bounding to the specific identification and avoid the additional power consumption to decode the unnecessary messages.

Optionally, the processor 111 determines at least one low-power base station candidate from the at least one low-power base station 13 in an unsolicited manner. In other words, the processor 111 determines at least one low-power base station candidate from the at least one low-power base station 13 without any requests, and the transceiver 113 of the high-power base station 11 transmits the control information 12 without any request. Similarly, the control information 12 could also be transmitted by unicasting, broadcasting, or allocating one or more specific identifications as described above.

In another embodiment, the request 14 comprises a cell identification of the at least one low-power base station candidate detected by the at least one user end 15. The number of the cell identification is dependent on that of the at least one user end 15. Specifically, the at least one user end 15 could fail to receive the control information 12 from the at least one low-power base station 13 but detects one or more cell identification other than the cell identification of the high-power base station 11. In this case, the request 14 may comprises the full or partial information of the cell identification which is detected by the at least one user end 15, and the transceiver 113 of the high-power base station 11 may response to the at least one user end 15 with the information related to the cell identification, such as the cell type, the control information 12 or other information related to the control information 12.

In another embodiment, the request 14 comprises a signal measurement report of the at least one low-power base station candidate measured by the at least one user end 15 in the data channel 18. The number of the signal measurement report is dependent on that of the at least one user end 15. Specifically, the at least one user end 15 could fail to receive the control information 12 from the at least one low-power base station 13 and detect any cell identification of the at least one low-power base station 13. The signal measurement report may comprise the information related to the signal strength, such as the received signal strength of each subframe.

Since different subframes may be allocated to different base stations in the data channel 18 for the purpose of interference management, the processor 111 of the high-power base station 11 could estimate the at least one low-power base station candidate which has better signal quality for the at least one user end 15 when the high-power base station 11 obtains the signal strength of each subframe measured by the at least one user end 15.

Moreover, the signal measurement report may contain other information instead of the signal strength per subframe. For example, the heterogeneous network system 1 may allocate radio resource to assist the at least one user end 15 to estimate the channel status of different base stations. The allocated radio resource may be different set of subcarriers in a subframe, and different base stations may transmit specific signal patterns in different sets of subcarriers.

The at least one user end 15 may be aware of the existence of the specific radio resource and measure the signal quality such as signal strength of each set of the subcarriers, and transmits the signal measurement report containing the signal quality measured by the at least one user end 15 to the high-power base station 11. Upon the transceiver 113 of the high-power base station 11 receives the signal measurement report, the processor 111 of the high-power base station 11 could estimate the signal quality between each of the at least one low-power base station 13 to the at least one user end 15 since it knows the subcarrier set in which the at least one low-power base station 13 transmits signals.

In doing so, the processor 111 of the high-power base station 11 could determine the at least one low-power base station candidate with better signal quality from the at least one low-power base station 13, and the transceiver 113 of the high-power base station 11 could transmits more information such as the cell identification of the at least one low-power base station 13, the control information 12 or other information related to the control information 12 to the at least one user end 15 to assist it to detect other low-power base station 13.

The subcarrier set may be calculated from some parameters, such as the cell identification of the at least one low-power base station 13. For example, the subcarrier set may be determined by Mod (cell identification, x), where x is an integer such as 3 or 6. Thus, there are three or six possible subcarrier sets and the at least one user end 15 may attempt the measure the channel status at the possible subcarrier sets and report the measurement result to the high-power base station 11. When the transceiver 113 of the high-power base station 11 receives the signal measurement report, the processor 111 of the high-power base station 11 may have the information about that which low-power base station 13 in its coverage is closer to the at least one user end 15. The possible subcarrier sets can also be the reference signals, training sequences, or synchronization channels of different low-power base station 13.

On the other hand, the subcarrier sets may also be transparent to the at least one user end 15. For example, the high-power base station 11 can request the at least one user end 15 to measure specific radio resource sent by other low-power base station 13 using existing mechanism, and the at least one user end 15 does not need to know the source of the signals sent in the radio resource indicated by the high-power base station 11. Therefore, the processor 111 of the high-power base station 11 can gather the channel statuses from different base stations based on the signal measurement report sent by the at least one user end 15, and the transceiver 113 of the high-power base station 11 can transmit handover suggestion to the at least one user end 15 or other information which could assist the at least one user end 15 to detect other low-power base station 13.

When the at least one user end 15 successfully detects the cell identification or the control information 12 of the at least one low-power base station 13, or the high-power base station 11 is aware of that the at least one user end 15 is in the coverage of the at least one low-power base station 13, handover procedure initialized by the at least one user end 15 or the high-power base station 11 could be performed. During the handover procedure, the transceiver 113 of the high-power base station 11 could transmit information which can assist the at least one user end 15 to fast connect to the target low-power base station 13. This information may include the control information 12 or the cell identification of the target low-power base station 13 or some information related to the control information 12 which is helpful for the at least one user end 15 to maintain connection to the target low-power base station 13 after it is attached to the target low-power base station 13.

The heterogeneous network system 1 could be any communication network system, such as the LTE series of the 3GPP, the Worldwide Interoperability for Microwave Access (WiMAX), etc. In other words, the heterogeneous network system 1 is applicable to various different communication network specifications. For example, if the heterogeneous network system 1 conforms to the LTE series of the 3GPP, the high-power base station 11 may be a Macro Base Station (MBS), the at least one low-power base station 13 may be a Pico Base Station (PBS), the at least one user end 15 may be a User Equipment (UE), the specific identification may be a Radio Network Temporary Identifier (RNTI) value, the data channel 18 may be a Physical Downlink Shared Channel (PDSCH), the scheduling channel may be a Physical Downlink Control Channel (PDCCH) or an Enhanced PDCCH (EPDCCH), the control channel 16 may be one of the Physical Broadcast Channel (PBCH), the Primary Synchronization Channel (PSCH) and the Secondary Synchronization Channel (SSCH), and the control information 12 of the at least one low-power base station candidate or the control information 10 of the high-power base station 11 may comprise a Master Information Block (MIB).

In the first aspect, a second embodiment of the present invention provides a transmission method applied to a high-power base station for use in a heterogeneous network system in which at least one low-power base station has time and frequency synchronization with the high-power base station in a control channel and a CRE bias with the high-power base station, and a flowchart diagram of which is shown in FIG. 1C.

The transmission method may be applied to the high-power base station 11 as described in the first embodiment. Therefore, the high-power base station described in this embodiment may be considered as the high-power base station 11 of the first embodiment. The high-power base station described in this embodiment comprises a processor and a transceiver connected electrically with the processor.

As shown in FIG. 1C, the step SH is executed to determine at least one low-power base station candidate from the at least one low-power base station by the processor, and the step S13 is optionally executed to allocate a specific identification to the at least one user end by the processor so that the at least one user end receives the control information of the at least one low-power base station candidate according to the specific identification in a scheduling channel. The step S15 is executed to transmit control information of the at least one low-power base station candidate to at least one user end in the control channel by the transceiver. The step S13 is not an absolutely essential step and it may be omitted in another embodiment.

Optionally, the step SH may be a step of determining the at least one low-power base station candidate according to a request of the at least one user end by the processor in another embodiment. The request may comprise a cell identification of the at least one low-power base station candidate detected by the at least one user end. Alternatively, the request may comprise a signal measurement report of the at least one low-power base station candidate measured by the at least one user end in a data channel.

In addition to the aforesaid steps, the transmission method of this embodiment may comprises other steps corresponding to all the operations of the high-power base station 11 set forth in the first embodiment and accomplish all the corresponding functions. Since the steps which are not described in this embodiment can be readily appreciated by persons of ordinary skill in the art based on the explanations of the first embodiment, they will not be further described herein.

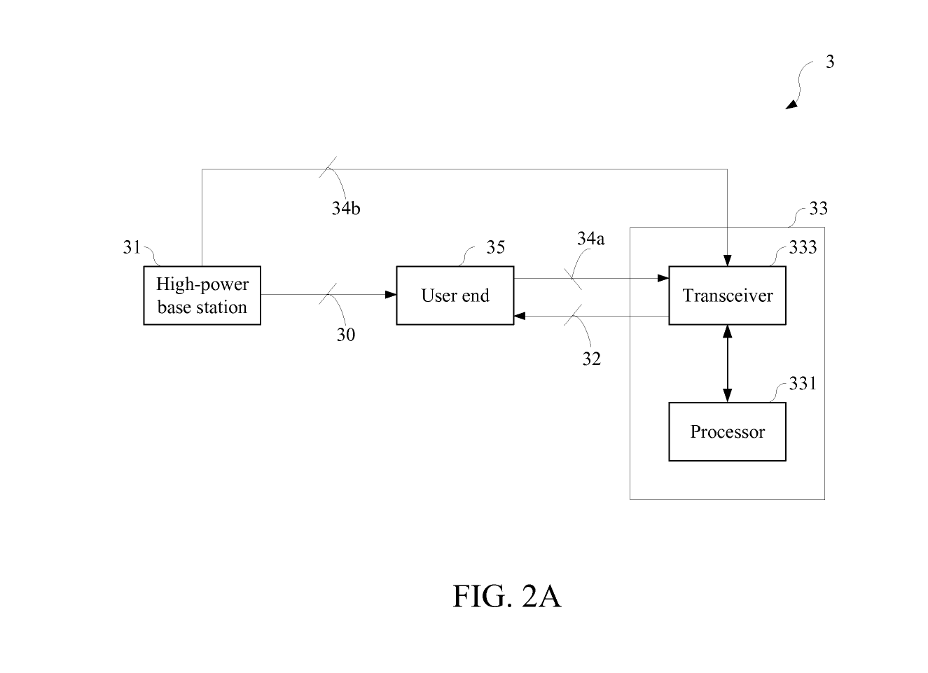

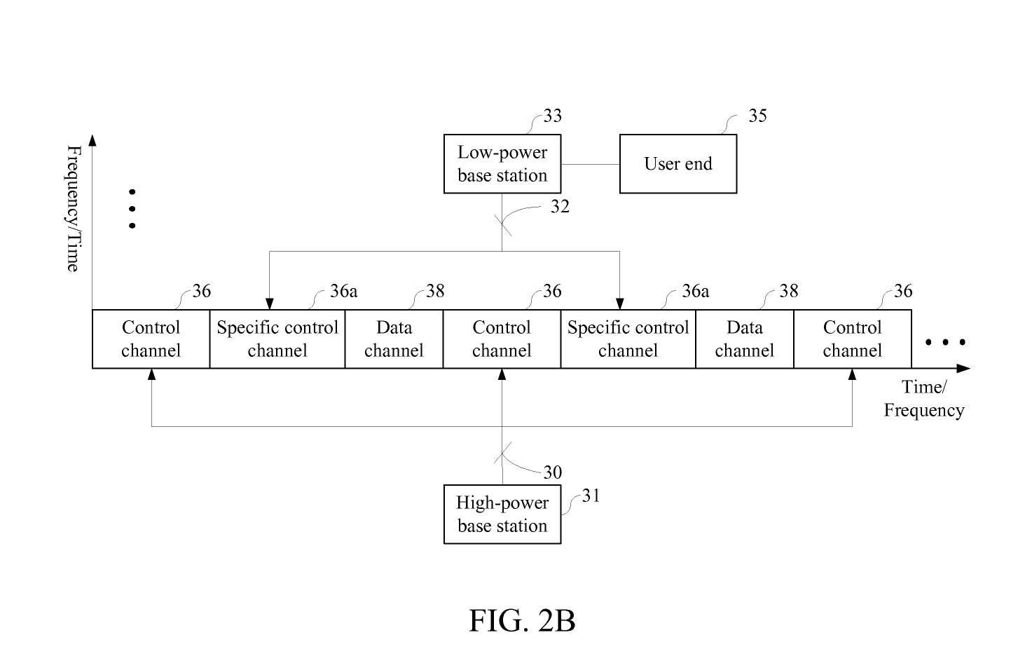

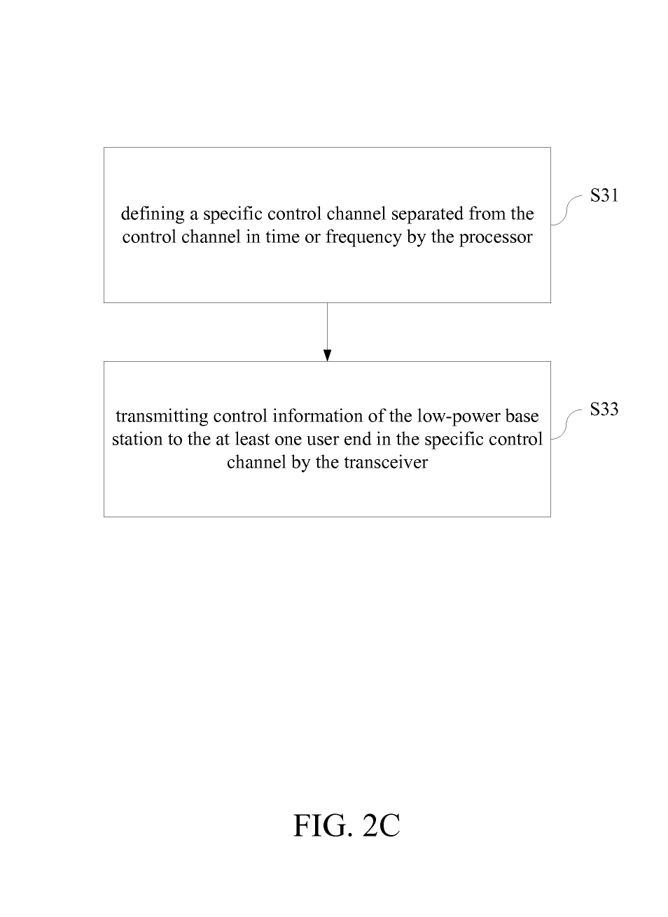

In the second aspect, a third embodiment of the present invention provides a low-power base station for use in a heterogeneous network system in which at least one high-power base station (i.e., one or more high-power base stations) has time and frequency synchronization with the low-power base station in a control channel and a CRE bias with the low-power base station and at least one user end (i.e., one or more user ends) is attached to the low-power base station, and a schematic structural view of which is show in FIG. 2A.

For ease of descriptions, only one high-power base station and one use end are considered in this embodiment because persons of ordinary skill can readily understand the operations of multiple high-power base stations and multiple user ends based on the following descriptions.

As shown in FIG. 2A, a heterogeneous network system 3 comprises a high-power base station 31, one low-power base station 33 and one user end 35, and the low-power base station 33 comprises a processor 331 and a transceiver 333 connected electrically with the processor 331. In this embodiment, the user end 35 has attached to the low-power base station 33 via some procedures such as handover procedures. That is the user end 35 is within the coverage range of the low-power base station 33 and served by the low-power base station 33.

The low-power base station 33 is deployed in the coverage range of the high-power base station 31 and has a CRE bias with the high-power base station 31. In other words, the low-power base station 33 has a power bias (such as 9 dB bias stipulated in the LTE series) with the high-power base station 31. The details of the CRE bias can be appreciated readily to persons skilled in the art, and thus will not be further described herein. Note that the LTE series at least includes the LTE and the LTE-A systems.

FIG. 2B is a schematic view illustrating channel status of the heterogeneous network system 3 in a time-frequency two-dimensional domain. In FIG. 2B, one axis represents time while another axis represents frequency, and vice versa. As shown in FIG. 2A and FIG. 2B, the low-power base station 33 has time and frequency synchronization with the high-power base station 31 in a periodic control channel 36. Specifically, the high-power base station 31 and the low-power base station 33 have obtained subframe-level synchronization with which the subframe boundaries of these base stations can be regarded as aligned. Moreover, theses base stations transmit their control information in the same resource block.

Therefore, if the high-power base station 31 transmits its control information 30 to the user end 35 in a control channel such as the control channel 36 in which the low-power base station 33 transmit its control information 32 to the user end 35, the control information 32 with lower power could be interfered by the control information 30 with higher power in the control channel 36. The control information 30 comprises any information which could assist the user end 35 to connect with the high-power base station 31, while the control information 32 comprises any information which could assist the user end 35 to connect with the low-power base station 33.

Since the control information 32 may be time-varying, the user end 35 still need the control information 32 to keep the connection with the low-power base station 33 even the user end 35 has attached to the low-power base station 33. Therefore, the interference caused by the high-power base station 31 still exist in the periodic control channels 36 even the user end 35 has attached to the low-power base station 33.

To solve the problem, the processor 331 is configured to define a specific control channel 36a separated from the periodic control channel 36 in time or frequency, while the transceiver 333 is configured to transmit the control information 32 of the low-power base station 33 to the user end 35 in the specific control channel 36a. The specific control channel 36 may be a periodical channel or a non-periodical channel according to different applications. As the periodic control channel 36 is a periodical channel, the transceiver 333 periodically transmits the control information 32 of the low-power base station 33 to the user end 35 in more specific control channel 36a separated from the periodic control channel 36 in time or frequency.

To reduce the overhead caused by periodically transmitting the control information 32, the low-power base station 33 may start to periodically transmit the control information 32 upon it receives a request 34a from the user end 35 or a notification 34b from the high-power base station 31.

For example, when a handover procedure from the high-power base station 31 to the low-power base station 33 is finished, the high-power base station 31 may be aware of that it may introduce interference to the periodic control channel 36. Thus, the high-power base station 31 may indicate the low-power base station 33 with the request 34a to start periodically transmit the control information 32 in the specific control channels 36a and indicate the user end 35 with the parameters of the control information 32 (e.g., the starting subframe, the transmission period, the resource location). The parameters of the control information 32 can also be regarded as any information related to the control information 32.

Some existing mechanisms such as paging mechanisms can also be adopted to assist the transmission of the control information 32. Under the paging mechanisms, the user end 35 can listen to the paging message which is transmitted periodically using a specific identification. The paging message may contain the information about whether the control information 32 is changed. If the user end 35 receives the paging message which indicates that the control information 32 is changed, then the message carrying the changed control information 32 will appear in a radio resource which can be calculated.

Specifically, upon the user end 35 receives a paging message which indicates that the control information 32 is changed, the paging message carrying the changed control information 32 will appear in the resource blocks around the center frequency in the next three subframes or in the subframe 0 of the next frame. Alternatively, the information of whether the control information 32 is changed can also be carried periodically in the channels (i.e., scheduling channels) which carry the scheduling information.

Taking the LTE series as an example, if there is no particular format with a specific identification detected in the scheduling channel, then the user end 35 determines that the control information 32 is not changed. Otherwise, if the user end 35 receives a particular format with a specific identification, then it determines that the control information 32 is changed and it will attempt to detect the message carrying the control information 32 in the radio resource which can be calculated as described above. In the case that the user end 35 fails to receive the paging message or scheduling information, it may assume that the control information 32 is changed and attempt to detect the message carrying the control information 32 in the possible resource.

In another embodiment, any information related to the control information 32 may also be carried in the channels which carry the scheduling information. To avoid the significant modification of the current system, the information related to the control information 32 could be carried in the format with similar characteristic (e.g. the same length) of the current formats.

Taking the LTE series as an example, the information related to the control information 32 can be carried in a format which has the same size as that of format 1C, and the CRC of the format is masked by some specific identifications. This design has the benefit that it will not affect the original mechanism of the original system. In this case, carrying the information related to the control information 32 by a format with the same size of format 1C will not affect the blind decoding mechanism of the original LTE system and thus will not affect the legacy user ends.

In another embodiment, the control information 32 of the low-power base station 33 may comprise a plurality of sub-information parts, and the transceiver 333 further transmits the sub-information parts with different periods/frequencies in a plurality of specific control channel 36a defined by the processor 331, and the specific control channels 36a are separated from the control channel 36 in time or frequency. Specifically, a part of the control information 32 may not be changed frequently, so the control information 32 may be divided into several sub-information parts and they may be transmitted with different periods in a plurality of specific control channel 36a. For example, the control information 32 comprises the system bandwidth, the Cell Specific Reference (CRS) port, and the Hybrid Automatic Repeat Request (HARD) setting. Since the system bandwidth may be a semi-statistic parameter and thus is not changed frequently, it may not be needed to be transmitted with the same period as other parameters.

The heterogeneous network system 3 could be any communication network system, such as the LTE series of the 3GPP, the WiMAX, etc. In other words, the heterogeneous network system 3 is applicable to various different communication network specifications. For example, if the heterogeneous network system 3 conforms to the LTE series of the 3GPP, the high-power base station 31 may be a MBS, the low-power base station 33 may be a PBS, the user end 35 may be a UE, the specific identification may be a RNTI value, the data channel 38 may be a PDSCH, the scheduling channel may be a PDCCH, or an EPDCCH, the control channel 36 or the specific control channel 36a may be one of the PBCH, the PSCH and the SSCH, and the control information 32 of the low-power base station 33 or the control information 30 of the high-power base station 31 may comprise a MIB.

In the second aspect, a fourth embodiment of the present invention provides a transmission method applied to a low-power base station for use in a heterogeneous network system in which one high-power base station has time and frequency synchronization with the low-power base station in a control channel and a CRE bias with the low-power base station and at least one user end is attached to the low-power base station, and a flowchart diagram of which is shown in FIG. 2C.

The transmission method may be applied to the low-power base station 33 as described in the third embodiment. Therefore, the low-power base station described in this embodiment may be considered as the low-power base station 33 of the third embodiment. The low-power base station described in this embodiment may comprise a processor and a transceiver connected electrically with the processor.

As shown in FIG. 2C, the step S31 is executed to define a specific control channel separated from the control channel in time or frequency by the processor, while the step S33 is executed to transmit control information of the low-power base station to the at least one user end in the specific control channel by the transceiver. Optionally, the transceiver starts to transmit the control information according to a request of the at least one user end or a notification of the high-power base station.

In another embodiment, the control information of the low-power base station may comprise a plurality of sub-information parts, and the step S33 is a step of transmitting the sub-information parts of the low-power base station to the at least one user end with different periods in a plurality of specific control channel defined by the processor by the transceiver, wherein the specific control channels are separated from the control channel in time or frequency.

In addition to the aforesaid steps, the transmission method of this embodiment may comprises other steps corresponding to all the operations of the low-power base station 33 set forth in the third embodiment and accomplish all the corresponding functions. Since the steps which are not described in this embodiment can be readily appreciated by persons of ordinary skill in the art based on the explanations of the third embodiment, they will not be further described herein.

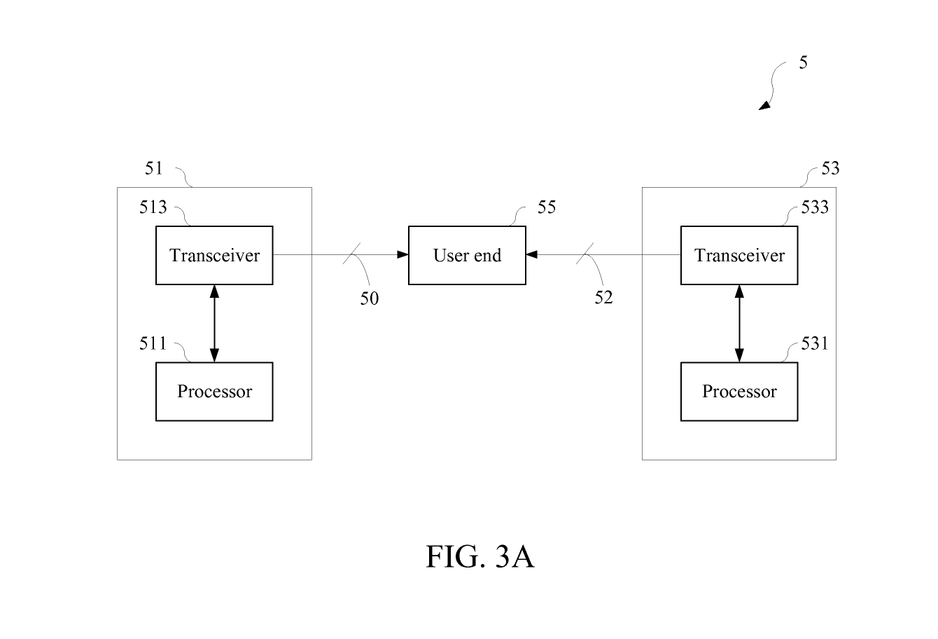

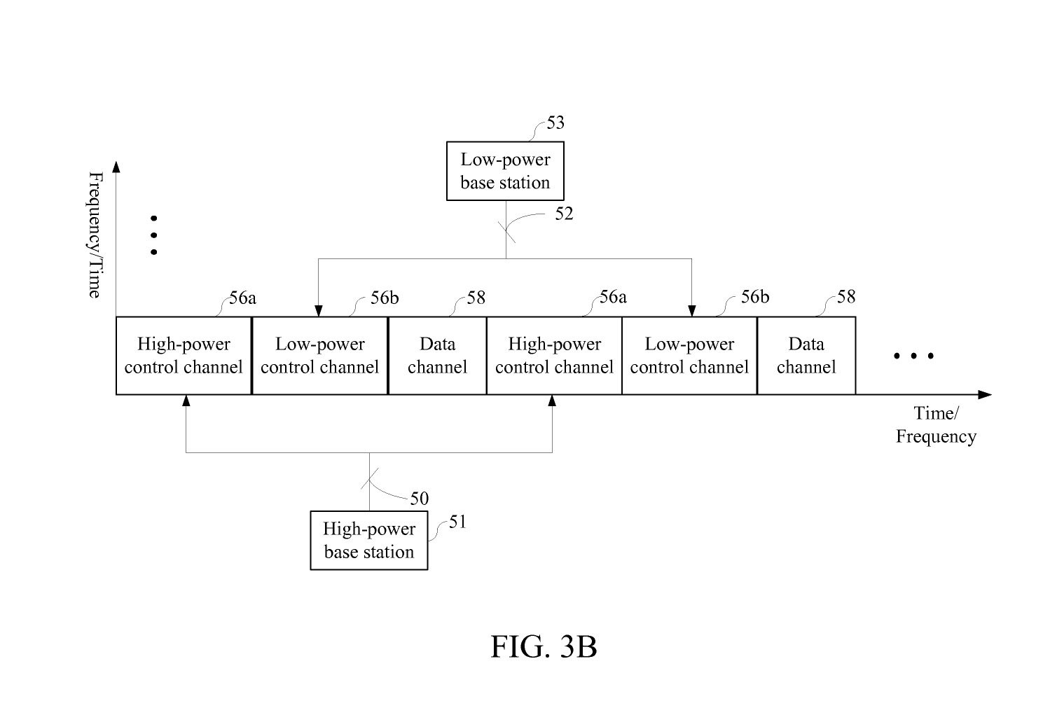

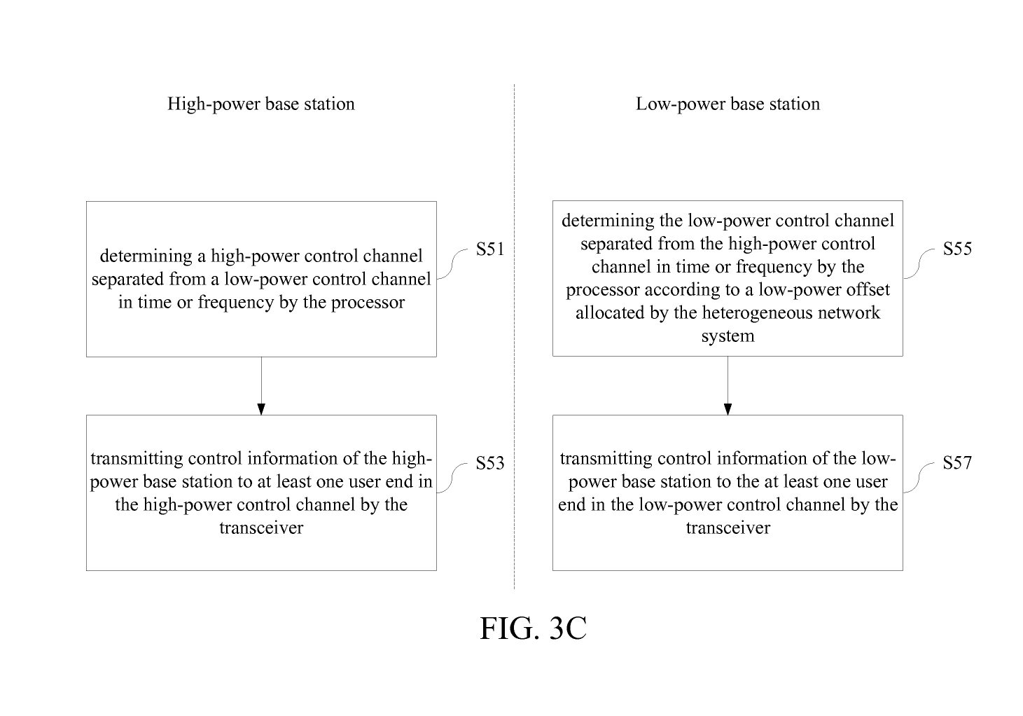

In the third aspect, a fifth embodiment of the present invention provides at least one high-power base station (i.e., one or more high-power base stations) and at least one low-power base station (i.e., one or more low-power base stations) for use in a heterogeneous network system, and a schematic structural view of them is show in FIG. 3A. The at least one high-power base station has a CRE bias with the at least one low-power base station.

For ease of descriptions, only one high-power base station, one low-power base station and one use end are considered in this embodiment because persons of ordinary skill can readily understand the operations of multiple high-power base stations, multiple low-power base stations and multiple user ends based on the following descriptions.

As shown in FIG. 3A, a heterogeneous network system 5 comprises a high-power base station 51, a low-power base station 53 and a user end 55. The high-power base station 51 comprises a processor 511 and a transceiver 513 connected electrically with the processor 511, and the low-power base station 53 comprises a processor 531 and a transceiver 533 connected electrically with the processor 531.

The low-power base station 53 is deployed in the coverage range of high-power base station 51 and has a CRE bias with the high-power base station 51. In other words, low-power base station 53 has a power bias (such as 9 dB bias stipulated in the LTE series) with the high-power base station 51, and the user end 55 would be connected with the low-power base station 53 rather than the high-power base station 51 if the power difference between the high-power base station 51 and the low-power base station 53 is within a range of the power bias. The details of the CRE bias can be appreciated readily to persons skilled in the art, and thus will not be further described herein. Note that the LTE series at least includes the LTE and the LTE-A systems.

FIG. 3B is a schematic view illustrating channel status of the heterogeneous network system 5 in a time-frequency two-dimensional domain. In FIG. 3B, one axis represents time while another axis represents frequency, and vice versa. As shown in FIG. 3A and FIG. 3B, the low-power base station 53 has time and frequency synchronization with the high-power base station 51 in a high-power control channel 56a. Specifically, the high-power base station 51 and the low-power base station 53 have obtained subframe-level synchronization with which the subframe boundaries of these base stations can be regarded as aligned. Moreover, theses base stations transmit their control information in the same resource block.

Therefore, if the high-power base station 51 transmits its control information 50 to the user end 55 in a control channel such as the high-power control channel 56a in which the low-power base station 53 transmit its control information 52 to the user end 55, the control information 52 with lower power could be interfered by the control information 50 with higher power in the high-power control channel 56a. The control information 50 comprises any information which could assist the user end 55 to connect with the high-power base station 51, while the control information 52 comprises any information which could assist the user end 55 to connect with the low-power base station 53.

To solve the problem, the processor 511 of the high-power base station 51 is configured to determine the high-power control channel 56a separated from the low-power control channel 56b in time or frequency, while the transceiver 513 of the high-power base station 51 is configured to transmit control information 50 of the high-power base station 51 to the user end 55 in the high-power control channel 56a. Optionally, the transceiver 513 of the high-power base station 51 may transmit the control information 50 to the user end 55 in the high-power control channel 56a based on a high-power offset allocated by the heterogeneous network system 5.

In addition, the processor 531 of the low-power base station 53 is configured to determine the low-power control channel 56b separated from the high-power control channel 56a in time or frequency according to a low-power offset allocated by the heterogeneous network system, while the transceiver 533 of the low-power base station 53 is configured to transmit control information 52 of the low-power base station 53 to the user end 55 in the low-power control channel 56b.

With properly allocate the high-power offset and the low-power offset to the high-power base station 51 and the low-power base station 53 respectively, the interference problem in the control channels can be effectively mitigated or avoided. The high-power offset and the low-power offset may be calculated from parameters of the high-power base station 51 and the low-power base station 53 respectively, for example, the cell identifications of the high-power base station 51 and the low-power base station 53.

Under the design, a base station can indicate a use end the cell identifications of other base stations and the user end could calculate the location of a specific control channel, and then improve the efficiency for the user end to detect other base stations. This design can also facilitate the measurement mechanism of the user end in which the user end can measure some parameters such as signal strength in the radio resource of the possible location of control channels and transmit the signal measurement report to the base station to which it attaches, as described above.

The heterogeneous network system 5 could be any communication network system, such as the LTE series of the 3GPP, the WiMAX, etc. In other words, the heterogeneous network system 5 is applicable to various different communication network specifications. For example, if the heterogeneous network system 5 conforms to the LTE series of the 3GPP, the high-power base station 51 may be a MBS, the low-power base station 53 may be a PBS, the user end 55 may be a UE, the specific identification may be a RNTI value, the data channel 58 may be a PDSCH, the high-power control channel 56a or the low-power control channel 56b may be one of the PBCH, the PSCH and the SSCH, and the control information 52 of the low-power base station 53 or the control information 50 of the high-power base station 51 may comprise a MIB.

In the third aspect, a sixth embodiment of the present invention provides two transmission methods respectively applied to a low-power base station and a high-power base station for use in a heterogeneous network system, and a flowchart diagram of which is shown in FIG. 3C. The low-power base station has a CRE bias with the high-power base station.

The two transmission methods may be applied respectively to the low-power base station 53 and the high-power base station 51 as described in the fifth embodiment. Therefore, the low-power base station and the high-power base station described in this embodiment may be considered as the low-power base station 53 and the high-power base station 51 of the fifth embodiment. The low-power base station described in this embodiment may comprise a processor and a transceiver connected electrically with the processor, and the high-power base station described in this embodiment may comprise a processor and a transceiver connected electrically with the processor.

As shown in FIG. 3C, the transmission method applied to the high-power base station comprises steps S51 and S53, while the transmission method applied to the low-power base station comprises steps S55 and S57.

The step S51 is executed to determine a high-power control channel separated from a low-power control channel in time or frequency by the processor, while the step S53 is executed to transmit control information of the high-power base station to at least one user end in the high-power control channel by the transceiver. Optionally, the step S51 is a step of determining the high-power control channel separated from the low-power control channel in time or frequency by the processor according to a high-power offset allocated by the heterogeneous network system.

The step S55 is executed to determine the low-power control channel separated from the high-power control channel in time or frequency by the processor according to a low-power offset allocated by the heterogeneous network system, while the step S57 is executed to transmit control information of the low-power base station to the at least one user end in the low-power control channel by the transceiver.

In addition to the aforesaid steps, the two transmission method of this embodiment may comprises other steps corresponding to all the operations of the high-power base station 51 and the low-power base station 53 set forth in the fifth embodiment and accomplish all the corresponding functions. Since the steps which are not described in this embodiment can be readily appreciated by persons of ordinary skill in the art based on the explanations of the fifth embodiment, they will not be further described herein.

According to the above descriptions, the present invention provides a high-power base station and a low-power base station for use in a heterogeneous network system and transmission methods thereof.

In the first aspect of the present invention, the at least one user end receives control information of the low-power base station from the high-power base station in the same control channels. Therefore, the interference caused by the high-power base station in control channels of the heterogeneous network system can be avoided effectively. Likewise, the transmission method of the first aspect is applied to the high-power base station to implement the same effects.

In the second aspect of the present invention, the at least one user end attached to the low-power base station receives control information of the low-power base station from the low-power base station in a specific control channel which is pre-defined by the low-power base station to be separated from the control channel in time or frequency. Therefore, the interference caused by the high-power base station in control channels of the heterogeneous network system can be avoided effectively. Likewise, the transmission method of the second aspect is applied to the low-power base station to implement the same effects.

In the third aspect of the present invention, the user end receives control information of the low-power base station from the low-power base station in the low-power control channel which is determined based on a low-power offset allocated by the heterogeneous network system to be separated from the high-power control channel in which the high-power base station transmits its control information in time or frequency. Therefore, the interference caused by the high-power base station in control channels of the heterogeneous network system can be avoided effectively. Likewise, the transmission methods of the third aspect are applied to the high-power base station and the at least one low-power base station to implement the same effects.

The above disclosure is related to the detailed technical contents and inventive features thereof. Persons skilled in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A high-power base station for use in a heterogeneous network system in which at least one low-power base station has time and frequency synchronization with the high-power base station in a control channel and a Cell Range Expansion (CRE) bias with the high-power base station, comprising:
a processor, configured to determine at least one low-power base station candidate from the at least one low-power base station; and
a transceiver, connected electrically with the processor and configured to transmit control information of the at least one low-power base station candidate to at least one user end in the control channel.

2. The high-power base station as claimed in claim 1, wherein the processor determines the at least one low-power base station candidate according to a request of the at least one user end.

3. The high-power base station as claimed in claim 1, wherein the processor further allocate a specific identification to the at least one user end so that the at least one user end receives the control information of the at least one low-power base station candidate according to the specific identification in a scheduling channel.

4. The high-power base station as claimed in claim 2, wherein the request further comprises a cell identification of the at least one low-power base station candidate detected by the at least one user end.

5. The high-power base station as claimed in claim 2, wherein the request further comprises a signal measurement report of the at least one low-power base station candidate measured by the at least one user end in a data channel.

6. The high-power base station as claimed in claim 1, wherein the heterogeneous network system conforms to the specification of the long-term evolution (LTE) series of the 3rd Generation Partnership Project (3GPP), the control channel is one of the Physical Broadcast Channel (PBCH), the Primary Synchronization Channel (PSCH) and the Secondary Synchronization Channel (SSCH), and the control information of the at least one low-power base station candidate comprises a Master Information Block (MIB).

7. A transmission method applied to a high-power base station for use in a heterogeneous network system in which at least one low-power base station has time and frequency synchronization with the high-power base station in a control channel and a CRE bias with the high-power base station, the high-power base station comprising a processor and a transceiver connected electrically with the processor, the transmission method comprising the steps:
(a) determining at least one low-power base station candidate from the at least one low-power base station by the processor; and
(b) transmitting control information of the at least one low-power base station candidate to at least one user end in the control channel by the transceiver.

8. The transmission method as claimed in claim 7, wherein the step (a) is a step of determining the at least one low-power base station candidate according to a request of the at least one user end by the processor.

9. The transmission method as claimed in claim 7, further comprising the step:
(c) allocating a specific identification to the at least one user end by the processor so that the at least one user end receives the control information of the at least one low-power base station candidate according to the specific identification in a scheduling channel.

10. The transmission method as claimed in claim 8, wherein the request further comprises a cell identification of the at least one low-power base station candidate detected by the at least one user end.

11. The transmission method as claimed in claim 8, wherein the request further comprises a signal measurement report of the at least one low-power base station candidate measured by the at least one user end in a data channel.

12. The transmission method as claimed in claim 7, wherein the heterogeneous network system conforms to the specification of the LTE series of the 3GPP, the control channel is one of the PBCH, the PSCH and the SSCH, and the control information of the at least one low-power base station candidate comprises an MIB.

13. A low-power base station for use in a heterogeneous network system in which one high-power base station has time and frequency synchronization with the low-power base station in a control channel and a CRE bias with the low-power base station and at least one user end is attached to the low-power base station, comprising:
a processor, configured to define a specific control channel separated from the control channel in time or frequency; and
a transceiver, connected electrically with the processor and configured to transmit control information of the low-power base station to the at least one user end in the specific control channel.

14. The low-power base station as claimed in claim 13, wherein the transceiver starts to transmit the control information according to a request of the at least one user end or a notification of the high-power base station.

15. The low-power base station as claimed in claim 13, wherein the control information of the low-power base station comprises a plurality of sub-information parts, the transceiver further transmits the sub-information parts with different periods in a plurality of specific control channel defined by the processor, and the specific control channels are separated from the control channel in time or frequency.

16. The low-power base station as claimed in claim 13, wherein the heterogeneous network system conforms to the specification of the LTE series of the 3GPP, each of the control channel and the specific control channel is one of the PBCH, the PSCH and the SSCH, and the control information of the at least one low-power base station candidate comprises an MIB.

17. A transmission method applied to a low-power base station for use in a heterogeneous network system in which one high-power base station has time and frequency synchronization with the low-power base station in a control channel and a CRE bias with the low-power base station and at least one user end is attached to the low-power base station, the low-power base station comprising a processor and a transceiver connected electrically with the processor, the transmission method comprising the steps:
(a) defining a specific control channel separated from the control channel in time or frequency by the processor; and
(b) transmitting control information of the low-power base station to the at least one user end in the specific control channel by the transceiver.

18. The transmission method as claimed in claim 17, wherein the transceiver starts to transmit the control information according to a request of the at least one user end or a notification of the high-power base station.

19. The transmission method as claimed in claim 17, wherein the control information of the low-power base station comprises a plurality of sub-information parts, and the step (b) is a step of transmitting the sub-information parts of the low-power base station to the at least one user end with different periods in a plurality of specific control channel defined by the processor by the transceiver, wherein the specific control channels are separated from the control channel in time or frequency.

20. The transmission method as claimed in claim 17, wherein the heterogeneous network system conforms to the specification of the LTE series of the 3GPP, each of the control channel and the specific control channel is one of the PBCH, the PSCH and the SSCH, and the control information of the at least one low-power base station candidate comprises an MIB.

21. A high-power base station for use in a heterogeneous network system in which at least one low-power base station has a CRE bias with the high-power base station and transmits its control information to at least one user end in a low-power control channel based on a low-power offset allocated by the heterogeneous network system, comprising:
a processor, configured to determine a high-power control channel separated from the low-power control channel in time or frequency; and
a transceiver, connected electrically with the processor and configured to transmit control information of the high-power base station to the at least one user end in the high-power control channel.

22. The high-power base station as claimed in claim 21, wherein the processor determines the high-power control channel separated from the low-power control channel in time or frequency according to a high-power offset allocated by the heterogeneous network system.

23. The high-power base station as claimed in claim 21, wherein the heterogeneous network system conforms to the specification of the LTE series of the 3GPP, each of the high-power control channel and the low-power control channel is one of the PBCH, the PSCH and the SSCH, and each of the control information of the high-power base station and the at least one low-power base station comprises an MIB.

24. A transmission method applied to a high-power base station for use in a heterogeneous network system in which at least one low-power base station has a CRE bias with the high-power base station and transmits its control information to at least one user end in a low-power control channel based on a low-power offset allocated by the heterogeneous network system, the high-power base station comprising a processor and a transceiver connected electrically with the processor, the transmission method comprising the steps:
(a) determining a high-power control channel separated from the low-power control channel in time or frequency by the processor; and
(b) transmitting control information of the high-power base station to the at least one user end in the high-power control channel by the transceiver.

25. The transmission method as claimed in claim 24, wherein the step (a) is a step of determining the high-power control channel separated from the low-power control channel in time or frequency by the processor according to a high-power offset allocated by the heterogeneous network system.

26. The transmission method as claimed in claim 24, wherein the heterogeneous network system conforms to the specification of the LTE series of the 3GPP, each of the high-power control channel and the low-power control channel is one of the PBCH, the PSCH and the SSCH, and each of the control information of the high-power base station and the at least one low-power base station comprises an MIB.

27. A low-power base station for use in a heterogeneous network system in which one high-power base station has a CRE bias with the low-power base station and transmits its control information to at least one user end in a high-power control channel, comprising:
a processor, configured to determine a low-power control channel separated from the high-power control channel in time or frequency according to a low-power offset allocated by the heterogeneous network system; and
a transceiver, connected electrically with the processor and configured to transmit control information of the low-power base station to the at least one user end in the low-power control channel.

28. The low-power base station as claimed in claim 27, wherein the high-power base station transmits its control information to the at least one user end in the high-power control channel based on a high-power offset allocated by the heterogeneous network system.

29. The low-power base station as claimed in claim 27, wherein the heterogeneous network system conforms to the specification of the LTE series of the 3GPP, each of the high-power control channel and the low-power control channel is one of the PBCH, the PSCH and the SSCH, and each of the control information of the high-power base station and the at least one low-power base station comprises an MIB.

30. A transmission method applied to a low-power base station for use in a heterogeneous network system in which one high-power base station has a CRE bias with the low-power base station and transmits its control information to at least one user end in a high-power control channel, the low-power base station comprising a processor and a transceiver connected electrically with the processor, the transmission method comprising the steps:
(a) determining a low-power control channel separated from the high-power control channel in time or frequency by the processor according to a low-power offset allocated by the heterogeneous network system; and
(b) transmitting control information of the low-power base station to the at least one user end in the low-power control channel by the transceiver.

31. The transmission method as claimed in claim 30, wherein the high-power base station transmits its control information to the at least one user end in the high-power control channel based on a high-power offset allocated by the heterogeneous network system.

32. The transmission method as claimed in claim 30, wherein the heterogeneous network system conforms to the specification of the LTE series of the 3GPP, each of the high-power control channel and the low-power control channel is one of the PBCH, the PSCH and the SSCH, and each of the control information of the high-power base station and the at least one low-power base station comprises an MIB.
